(19) United States
(12) Patent Application Publication
(10) Pub. No.: US 2022/0184790 A1
(43) Pub. Date: Jun. 16, 2022

(54) SELF-ALIGNING TOOL GUIDE

(71) Applicant: Hilti Aktiengesellschaft, Schaan (LI)

(72) Inventors: Peer SCHMIDT, Lindau (DE); Dario BRALLA, Buchs (CH)

(21) Appl. No.: 17/432,267

(22) PCT Filed: Mar. 23, 2020
(86) PCT No.: PCT/EP2020/057936

§ 371 Date: Oct. 15, 2021

(30) Foreign Application Priority Data
Apr. 3, 2019 (EP) 19166942.3

(51) Int. Cl. B25D 17/28; B25H 1/00; B28D 1/14; B60L 50/60

(52) U.S. Cl. CPC B25D 17/28; B25H 1/0035; B28D 1/14; B60L 2260/34; B60L 2200/16; B60L 2200/40; B60L 50/60

(57) ABSTRACT

A tool guide has a holder, a lifting mechanism and a chassis. The holder is for fixing a portable power tool, and is mounted on the lifting mechanism. The lifting mechanism has a propulsion system for vertically raising the holder. The chassis has two wheels on a wheel axis, a drive which is coupled to the wheels, and a steering system. The lifting mechanism is rigidly mounted on the chassis. A center of gravity sensor is designed for detecting a lateral deflection x of the center of gravity G of the lifting mechanism in relation to the wheel axis. The steering system is designed to actuate the drive to output a torque which counteracts the deflection x. The lifting mechanism can be pivoted by means of a pivot drive. An inclination controller is designed to actuate the pivot drive in such a way that the inclination is minimized.

### FIELD OF THE INVENTION

The invention relates to a self-aligning tool guide and to a control method for the tool guide.

Suspended ceilings are a design element frequently encountered in large buildings, in particular in industrial and office buildings. Technical installations, for example electrical installations, ventilation systems, lighting and soundproofing, can be laid between the ceiling of the shell and the suspended ceiling and are accessible for subsequent inspection and maintenance. Supporting substructures of the installations and of the suspended ceiling are fastened with dowels, screws or similar elements which are anchored in the ceiling of the shell. In order to construct the suspended ceiling, holes into which the dowels can be inserted or the screws can be screwed are drilled into the ceiling of the shell. A lateral position of the holes is prespecified by the supporting substructure.

Drilling the holes is time-consuming. The user can reach the high hanging ceiling of the shell only with a ladder or a scaffold. The ladder has to be placed below the prespecified position, the user climbs up the ladder, drills the hole, climbs down the ladder and moves the ladder to the next position.

DE 33 28 582 A1 describes a mobile ceiling drilling and assembly device for mounting impact dowels in a room ceiling. The ceiling drilling device is based on an impact drill which is mounted on a telescopic column. The telescopic column is suspended in an oscillating manner from a trolley. The user can move the ceiling drilling device beneath a desired location, can set the impact drill with respect to the room ceiling by means of the column and can drill a hole into the ceiling. The impact drill can be controlled via a switch panel. For transportation via staircases, the device has to be dismantled into four parts—trolley, telescopic column, impact drill and switch panel.

### DISCLOSURE OF THE INVENTION

A refinement of the invention relates to a self-aligning tool guide. The tool guide has a holder, a lifting mechanism and a chassis. The holder is for fixing a portable power tool. The holder is mounted on the lifting mechanism. The lifting mechanism has a propulsion system for vertically raising the holder. The chassis has two wheels on a wheel axis, a drive which is coupled to the wheels, and a steering system. The lifting mechanism is rigidly mounted on the chassis. A center of gravity sensor is designed for detecting a lateral deflection of the center of gravity of the lifting mechanism in relation to the wheel axis. The steering system is designed to actuate the drive to output a torque which counteracts the deflection. An inclination sensor (37) serves to detect an inclination (36) of the lifting mechanism (7) in relation to the force of gravity in a frontal plane. The frontal plane is parallel to the wheel axis (28) and parallel to the lifting axis (25). The lifting mechanism (7) is mounted on the chassis (8) by means of a pivot joint, wherein a pivot axis (94) of the pivot joint (93) is inclined in relation to the frontal plane or is perpendicular to the frontal plane. A pivot drive (100) is coupled to the pivot joint (93) for adjusting an inclination (36) of the lifting axis (25) in relation to the wheel axis (28) in the frontal plane. An inclination controller (103) is designed to actuate the pivot drive (100) in such a way that the inclination (36) is minimized.

### BRIEF DESCRIPTION OF THE FIGURES

The following description explains the invention with reference to exemplary embodiments and figures, in which:

FIG. 1 shows the self-aligning tool guide from the front

FIG. 2 shows the self-aligning tool guide in section I-I

FIG. 3 shows the self-aligning tool guide when working on a ceiling in section I-I

FIG. 4 shows a status diagram

FIG. 5 shows a diagram for explaining the alignment (equilibrium)

FIG. 6 shows a diagram for explaining the alignment in the forward and backward direction

FIG. 7 shows a diagram for explaining the alignment in the transverse direction

FIG. 8 shows a diagram for explaining the alignment in the transverse direction

FIG. 9 shows a status diagram

Identical or functionally identical elements are indicated by the same reference symbols in the figures, unless stated otherwise. In the context of this description, vertically denotes a direction parallel to the force of gravity; horizontally denotes a direction or plane perpendicular to the force of gravity.

### EMBODIMENTS OF THE INVENTION

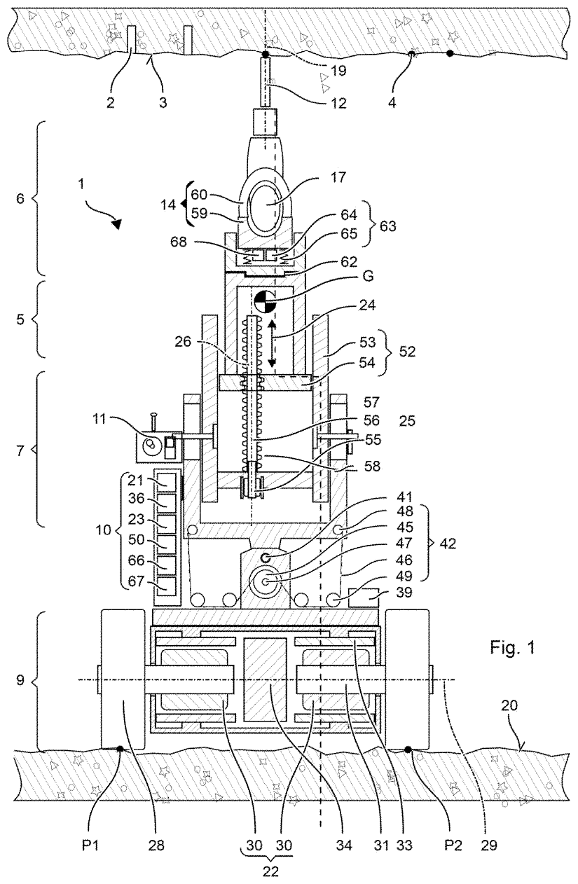

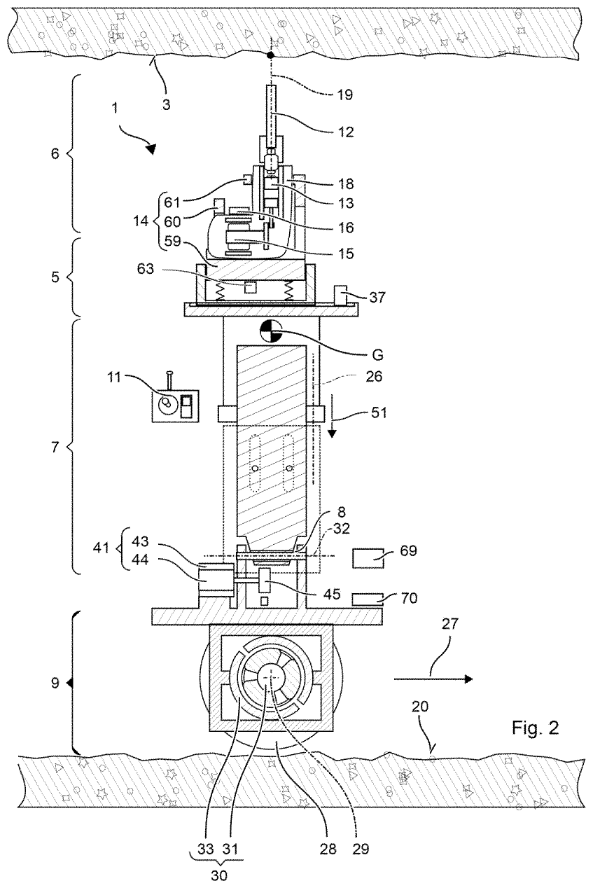

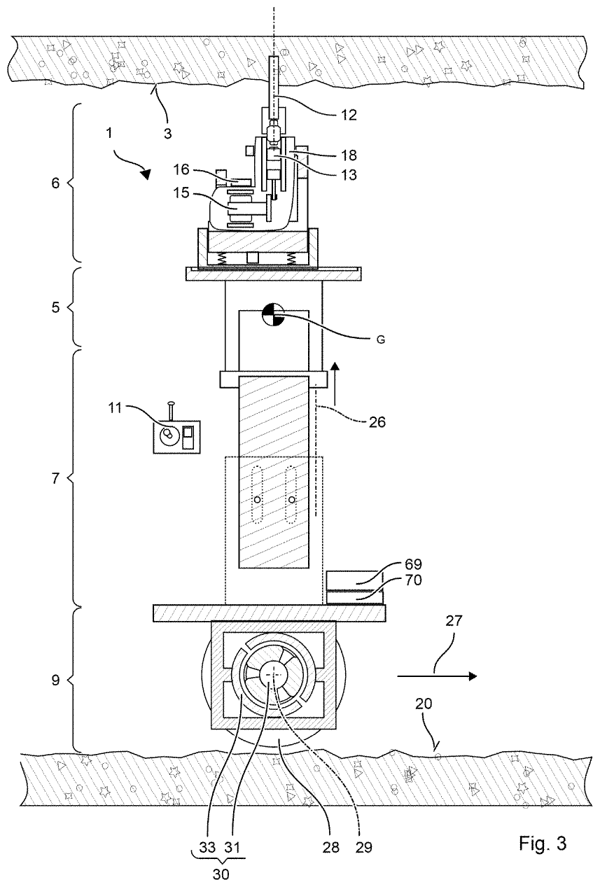

FIG. 1 and FIG. 2 show an exemplary self-aligning tool guide 1 for installation work in a shell. For example, installation of a ventilation pipe requires a plurality of holes 2 in a ceiling 3 of the shell. The holes 2 are intended to be located at prespecified positions 4, for example in alignment. Furthermore, the holes 2 are intended to be parallel to one another, for example vertically oriented. The position 4 is shown, for example, in a plan. A foreman can indicate the position 4 by color markings on the ceiling 3 of the shell. Other installation work on the ceiling 3 may comprise punching of nails, driving in of screws, sanding, etc.

FIG. 1 and FIG. 2 schematically show an embodiment of the self-aligning tool guide 1. The tool guide 1 has a holder 5 for a portable power tool 6, a motorized lifting mechanism 7, a motorized pivot joint 8, a motorized chassis 9, a controller 10 and a console 11.

The user can equip the tool guide 1 with a suitable portable power tool 6 and a suitable tool 12 according to the application. For drilling holes 2 into a shell, this would be, for example, a hammer drill with an impact mechanism 13 and a drill with a sintered carbide tip. The portable power tool 6 can be inserted into the holder 5 on the lifting mechanism 7. A lock 14 secures the portable power tool 6 in the holder 5. The lock 14 can preferably be released without a tool. In other embodiments, the portable power tool can be permanently connected, for example screwed, to the holder 5.

The hammer drill is just one example of a portable power tool 6. Other examples are an electric screwdriver, a nail setting tool, an angle grinder, a glue gun, a paint gun, etc. One type of portable power tool 6 drives an exchangeable tool 12, for example the drill, a chisel, a screwdriver bit, a cut-off wheel, etc. for the operation thereof. Another type of portable power tool 6 directly processes a consumable material, for example nails, screws, paint, adhesive. The portable power tools 6 are distinguished by their own drive with which the tool 12 is driven or the consumable material is driven in or applied. The user does not have to apply any manual force for using the portable power tool 6. The portable power tools are referred to as power tools. The power source 15 can be driven electrically or by fuel. Examples include an electric motor, an electric pump, a gas-fed internal combustion engine, a powder-driven piston, etc. The power source 15 is coupled to a (triggering) button 16. When the triggering button 16 is pressed, the power source 15 is activated. The triggering button 16 can preferably be remotely triggered or locked.

The portable power tool 6 can be a commercially available handheld portable power tool 6. The handheld portable power tool 6 has a handle 17 and typically a housing section 18 for fastening an additional handle. The portable power tool 6 can be designed without a handle. The holder 5 can also be configured for portable power tools which are not handheld.

The handheld power tool 6 have a working axis 19 which is defined by its construction. A tip of the tool 12 or a tip of the consumable material lies on the working axis 19. The tip is moved along the working axis 19. The tip first touches the underlying surface to be worked on, for example the ceiling 3.

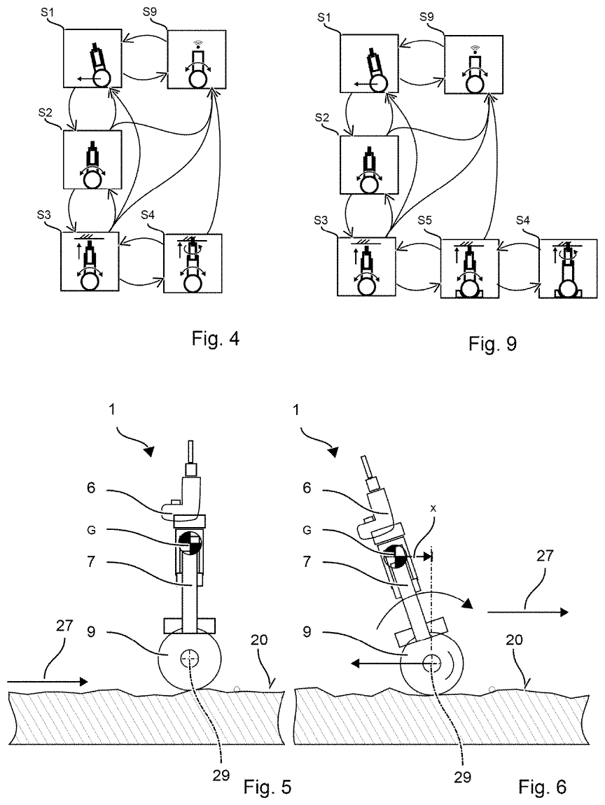

A status diagram of the tool guide 1 is shown in FIG. 4. The user activates the tool guide 1 by means of the console 11. The chassis 9 is in a (driving) mode S1 in which the user can move the tool guide 1 on the floor 20 through the space. The controller 10 activates a steering system 21 of the tool guide 1. The user can prespecify the direction of travel and the speed via the console 11. The user directs the tool guide 1 to one of the marked positions 4. The chassis 9 has a drive 22 which moves the chassis 9 over the floor 20 under its own force. The direction and the speed of movement of the chassis 9 are controlled by the steering system 21 of the tool guide 1. For this purpose, the steering system 21 processes, inter alia, the prespecifications in respect of speed and direction of travel which are input via the console 11.

The user holds the tool guide 1 at the marked position 4. The user switches the chassis 9 to a (standing) mode S2 via the console 11. The controller 10 blocks the steering system 21 for the user or switches the steering system 21 to render it inactive. The steering system 21 ignores prespecifications in respect of speed and direction of travel which are input via the console 11. The tool guide 1 remains in the currently assumed position 4. The steering system 21 can detect the current position 4. If the chassis 9 leaves the current position 4 or is moved out of said position, the steering system 21 automatically generates control signals in order to move the chassis 9 back to the detected position 4.

The user can activate a (lifting) mode S3 via the console 11 in order to raise the portable power tool 6 with the lifting mechanism 7. The controller 10 forces the standing mode S2 for the chassis 9 before the lifting mode can be activated. The controller 10 can delay the activation of the lifting mode until the chassis 9 is standing. A control station 23 for the user is enabled or activated in the lifting mode. The user can prespecify the direction of movement 24, i.e. up or down, the lifting speed and the position of the lifting mechanism 7 via the console 11. The holder 5 is correspondingly moved by the lifting mechanism 7. The control station 23 controls a propulsion system 25 of the lifting mechanism 7 taking into account the vertical direction of movement and lifting speed which are prespecified via the console 11. The lifting mechanism 7 lifts or lowers the holder 5 and possibly the portable power tool 6 inserted in it along a fixed lifting axis 26. The lifting mechanism 7 is limited to a single-axis, translatory movement on the lifting axis 26.

The working axis 19 of the portable power tool 6 is parallel to the lifting axis 26. In one refinement, the construction of the holder 5 forces the parallel alignment. The portable power tool 6 can be inserted in the holder 5 in only one defined way, for example due to a shape of the holder 5 matching a housing of the portable power tool 6. In one refinement, the holder 5 can be pivoted about a (pivot) axis which is inclined with respect to the lifting axis 26, in order to align the working axis 19 on the lifting axis 26.

Alignment of the lifting axis 26 and therefore of the working axis 19 in relation to the ceiling 3 is performed dynamically by the chassis 9. The chassis 9 vertically aligns the lifting axis 26, i.e. parallel to the force of gravity, at least provided that the chassis 9 is standing on a horizontal floor 20.

The portable power tool 6 can preferably be switched on via the control station 23. The tool 12 can work on the ceiling 3, for example can drill a hole 2. The controller 10 can have a (working) mode S4 which automatically controls the propulsion system 25 of the lifting mechanism 7 while working on the ceiling 3. The working mode can be activated manually, for example, at the console 11. In the working mode, the control station 23 matches the lifting speed of the lifting mechanism 7 to a working progress of the tool 12. The lifting mechanism 7 and the tool 12 can be protected against excessive loads. A working goal, for example a drill hole depth, can be prespecified to the control station 23. After the working goal has been reached, the control station 23 can automatically stop the propulsion system 25. In addition, the control station 23 can automatically lower the lifting mechanism 7 to an extent such that the tool 12 is disengaged from the ceiling 3.

The user can now deflect the tool guide 1 to a next marked position 4. The user switches the tool guide 1 over into the driving mode S1. The control station 23 is blocked for the user. The portable power tool 6 is forcibly switched off. Before start-up, the tool guide 1 can check whether the tool 12 is still in engagement with the ceiling 3. For example, the steering system 21 moves the chassis 9 by a small prespecified distance in one direction 27 and checks whether a counteracting torque is acting on the chassis 9. The steering system 21 moves the chassis 9 back to the previous position 4, switches to the standing mode and prompts the control station 23 to lower the lifting mechanism 7.

The chassis 9 has two wheels 28 which are coupled to the drive 22. The two wheels 28 are arranged offset in relation to one another on a transverse axis or wheel axis 29. The wheel axis 29 runs through the center of the two wheels 28. The wheels 28 can be parallel to one another, or the wheels 28 are inclined through a few degrees in relation to one another on account of a wheel camber and/or a toe angle. The two wheels 28 rotate substantially about the wheel axis 29. Each of the wheels 28 is coupled to the drive 22. The drive 22 can comprise, for example, two electric motors 30. The wheels 28 are each seated directly on a rotor 31 of one the electric motors 30. As an alternative, the wheels 28 can be coupled to a central electric motor 30 via clutches and a transmission. The drive 22 exerts a torque, which acts about the wheel axis 29, on the wheels 28. The rotationally driven wheels 28 move the chassis 9 over the floor 20. The chassis 9 moves in a straight line when the two wheels 28 rotate at the same speed. The wheels 28 can be driven individually by the drive 22. A different torque and a different rotation speed of the wheels 28 enable the chassis to travel around a corner. The wheels 28 can preferably be driven in opposite directions in order to rotate the chassis 9 about its vertical axis. The drive 22 receives control signals for the rotation speed and the torque of the two wheels 28 from the steering system 21. The steering system 21 generates the control signals in response to prespecified steering movements, for example steering movements which are prespecified by the user. The drive 22 can have a sensor system for detecting the output torque and rotation speed of the wheels 28. The measurement data detected can be transmitted to the steering system 21 in order to correct the deviations in the steering movement.

This chassis 9 and the tool guide 1 stand on the floor 20 only by way of the two wheels 28. The two contact points P1, P2 lie on a line which is parallel to the wheel axis 29. There is no third contact point with the floor 20 outside the line for a statically stable standing position. The tool guide 1 would fall over without countermeasures. The steering system 21 reaches a dynamic equilibrium by permanently balancing the center of gravity G of the lifting mechanism 7. On the basis of detection of the center of gravity G, the steering system 21 actuates the drive 22 to generate a torque which prevents falling.

The lifting mechanism 7 is mounted on the chassis 9 by means of the pivot joint 8. The lifting mechanism 7 can be inclined in relation to the chassis 9 only about a single pivot axis 32 which is prespecified by the pivot joint 8. The pivot axis 32 is preferably oriented perpendicularly to the wheel axis 29. The lifting mechanism 7 is arranged in an immobile manner in relation to the chassis 9, in particular to the drive 22 and to the wheel axis 29, with respect to the plane perpendicular to the wheel axis 29. The lifting mechanism 7 is preferably rigidly connected to a stator 33 of the drive 22. The drive 22 generates a torque and a reacting torque, of the same size and opposite direction of rotation, in principle in pairs. The torque acts on the wheels 28 via the rotor 31 of the drive 22. The reacting torque acts on the lifting mechanism 7 via the stator 33 of the drive 22.

The weight of the tool guide 1 is composed of the weight of the chassis 9 and the weight of the lifting mechanism 7. The weight of the portable power tool 6 is simply added to the weight of the lifting mechanism 7. The center of gravity of the chassis 9 lies approximately on the wheel axis 29. The wheels 28 of the drive 22 and batteries 34 are arranged symmetrically about the wheel axis 29. The center of gravity G of the lifting mechanism 7 lies above the wheel axis 29. The tool guide 1 stands, even if only in a metastable manner, when the center of gravity G is vertically above the wheel axis 29 (equilibrium, FIG. 5). A lateral deflection x is equal to zero. The tool guide 1 falls if the center of gravity G is offset in the lateral direction 35 in relation to the wheel axis 29, i.e. the lateral deflection x is unequal to zero (FIG. 6).

The steering system 21 has a (center of gravity) sensor 36 for detecting the lateral deflection x of the center of gravity G of the lifting mechanism 7. The lateral deflection x of the center of gravity G outside the equilibrium results in different measurable variables. The lifting mechanism 7 is inclined in relation to the force of gravity; the center of gravity sensor 36 can correspondingly comprise an inclination sensor. The falling movement leads to a characteristic acceleration; the center of gravity sensor 36 can comprise a gyro sensor, an acceleration sensor, a rate of rotation sensor, etc. for determining speed, acceleration, rate of rotation and/or rotational movement about the wheel axis 29. The inclined lifting mechanism 7 exerts a torque on the drive 22; the center of gravity sensor 36 can comprise a torque sensor, a force sensor, etc., for detecting a torque, a non-vertical force, etc. The sensors can detect the abovementioned variables on the basis of mechanical, optical, magnetic or electrical effects.

The steering system 21 comprises a control sequence which, on the basis of the deflection x, determines a torque for erecting the lifting mechanism 7. For example, the steering system 21 can prespecify a torque which is proportional to the deflection x. The steering system 21 transmits the torque in the form of a control signal to the drive 22 which generates the torque. The control sequence can comprise a control loop which corrects the deflection x to zero. Control parameters, such as the boost factor and the integral component, can preferably be adjusted, for example in order to adjust the control sequence to the different weight of the portable power tools 6.

The lifting mechanism 7 is vertically aligned by the motor power of the drive 22. The lifting mechanism 7 can be triggered by disturbances to the equilibrium and can oscillate repeatedly about the vertical alignment in reaction to the control sequence. Following the swinging action, the user cannot identify any further movement. The torque which acts on the lifting mechanism 7 is opposed by the torque which acts on the wheels 28. The wheels 28 rotate in a corresponding manner, as a result of which the chassis 9 travels in the direction 27 of the deflection x (FIG. 6). The chassis 9 oscillates analogously to the lifting mechanism 7 about a central position. Friction and grip of the wheels 28 on the floor 20 damp the oscillation.

The statically unstable standing position of the chassis 9 and the balancing are used in order to vertically align the lifting axis 26. At the dynamic equilibrium, the center of gravity G is situated vertically above the wheel axis 29. The lifting mechanism 7 is arranged with respect to the wheel axis 29 in such a way that a line which runs through the center of gravity G and the wheel axis 29 is parallel to the lifting axis 26. The exemplary lifting mechanism 7 has a compensating weight 37 on the holder 5 in order to adjust the position 4 of the center of gravity G for different portable power tools 6. The compensating weight 37 can be locked at different distances from the lifting axis 26. Instead of a compensating weight 37, the regulation can correct the deflection x to a prespecified offset. The offset preferably takes into account the actuating position of the lifting mechanism 7. The dynamic balancing vertically aligns the lifting axis 26 irrespective of the height of the lifting mechanism 7.

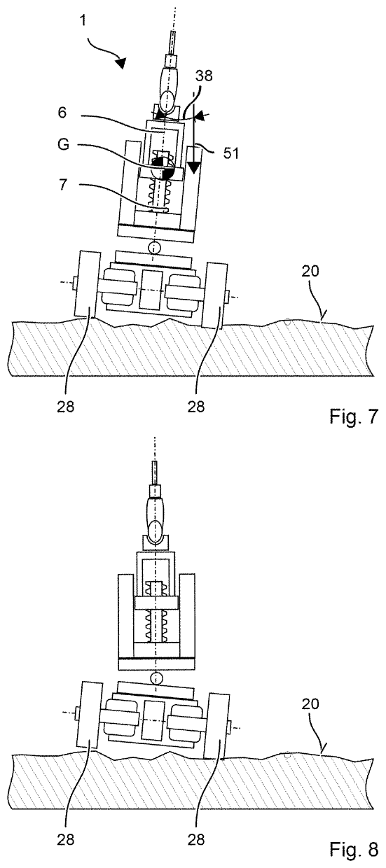

The dynamic balancing ensures vertical alignment when the wheel axis 29 lies horizontally. The deflection x lies in a plane which is perpendicular to the wheel axis 29. In the case of an uneven floor 20 or an inclined floor 20, the wheel axis 29 can be inclined with respect to the horizontal plane (FIG. 7). The inclination 38 of the wheel axis 29 is translated into an equal inclination of the lifting mechanism 7. The inclination 38 lies in the frontal plane of the tool guide 1. The frontal plane is spanned by the wheel axis 29 and the lifting axis 26. The inclination 38 of the wheel axis 29 cannot be directly compensated for by the dynamic balancing.

For working on the ceiling 3, the inclination 38 is preferably also compensated for. The exemplary controller 10 makes provision for the inclination 38 to be triggered when the lifting mode S3 is activated. The user or an external controller 10 will activate the lifting mechanism S3 when the tool guide 1 is positioned at the prespecified position 4. The compensation can also be triggered in a different mode. For example, a specific mode can be provided for the compensation, which mode is, for example, triggered automatically when the position 4 is reached or upon request by the user.

The tool guide 1 can compensate for the inclination 38 by deliberately pivoting the lifting mechanism 7 in relation to the chassis 9. The lifting mechanism 7 is fastened to the chassis 9 by means of the pivot joint 8. The pivot joint 8 enables the lifting mechanism 7 of the frontal plane to pivot. An inclination controller 39 and a (pivoting) drive 40 align the lifting mechanism 7 parallel to the direction of the force of gravity by way of the lifting mechanism 7 being pivoted about the pivot joint 8.

The pivot joint 8 has a single pivot axis 32 about which the lifting mechanism 7 can be pivoted in relation to the chassis 9. The pivot axis 32 is preferably perpendicular to the frontal plane or is at an angle of at least 45 degrees relative to the frontal plane. The orientation of the pivot axis 32 to the wheel axis 29 decouples the movements perpendicularly to the wheel axis 29 for dynamically balancing the chassis 9 and the movement for aligning the lifting mechanism 7 along the wheel axis 29.

The pivot drive 40 is preferably arranged in the vicinity of the pivot joint 8. The exemplary pivot drive 40 comprises an electric motor 41 and a belt drive 42. The electric motor 41 has a stator 43 which is mounted on the chassis 9, and a rotor 44 which is coupled to the lifting mechanism 7. Similarly, in another embodiment, the stator can be mounted on the lifting mechanism 7 and the rotor can be coupled to the chassis 9. The coupling of the rotor 31 is released by a belt drive 42. The belt drive 42 transmits a torque of the rotor 44 to the lifting mechanism 7 which is suspended from the pivot joint 8 and also a torque, which is exerted by the lifting mechanism 7, to the rotor 44. It is not necessary for the belt drive 42 to execute a movement for transmitting the torque, in contrast to the case for a transmission with gear wheels. Furthermore, no time offset between a torque which starts from the lifting mechanism 7 and a torque which starts from the electric motor 41 is produced. This allows more robust and more rapid correction of the inclination 38. A further substantial aspect is that a torque which is exerted by the lifting mechanism 7 has a retrospective effect on the rotor 44. Transmissions with gear wheels, for example planetary transmissions, can transmit a torque only from a drive spindle to an output spindle and inhibit movement in the opposite direction from the output spindle to the drive spindle. Simple transmissions with gear wheels are not suitable for correction of the pivot joint on account of their play.

The exemplary belt drive 42 has a drive roller 45 and a belt 46. The drive roller 45 is rigidly connected to the rotor 44. For example, the drive roller 45 can be fitted on a shaft 47 of the rotor 44. The belt 46 is guided over the drive roller 45. A torque of the drive roller 45 is introduced into the belt 46. The belt 46 is fastened to the lifting mechanism 7. The exemplary belt 46 is fastened to two points 48 in order to be able to transmit a torque in a rotation direction about the pivot axis 32 and a torque in an opposite rotation direction about the pivot axis 32 The two points can also coincide, wherein in this case the belt acts from two opposite directions. Additional auxiliary rollers 49 can guide and tension the belt.

The inclination controller 39 comprises an inclination sensor 50. The inclination sensor 50 can determine the inclination 38 of the lifting mechanism 7 in relation to the direction of the force of gravity 51 in the frontal plane. The inclination sensor 50 can be implemented, for example, by the center of gravity sensor 36 or analogously. The inclination sensor 50 can directly determine the inclination 38 of the lifting mechanism 7 in relation to the force of gravity or the inclination 38 indirectly by means of the inclination of the wheel axis 29 in relation to the horizontal plane. The inclination controller 39 corrects the pivot drive 40 in such a way that the inclination 38 is minimal.

The steering system 21 comprises, for example, a console 11 with input elements for the direction of travel and the speed. An exemplary console 11 is based on a biaxial joystick. Other consoles can have, for example, a steering wheel for the direction of travel and a slide for the speed. The console 11 can preferably be removed from the tool guide 1. The control signals which are generated by the console 11 are transmitted to the drive 22 in a radio-based manner, optically or in a line-based manner. The steering system 21 can detect a pushing or pulling force which is exerted on the chassis 9 by the user. Under the action of the force, the chassis 9 tilts in the direction 27 of the pushing or pulling force. The steering system 21 detects the deflection x of the chassis 9. A speed of the chassis 9 can be, for example, proportional to the deflection x.

The exemplary lifting mechanism 7 is based on a linear rail guide 52. Two parallel profile rails 53 are fastened on the chassis 9. The two profile rails 53 define the lifting axis 26. A rotor 54 engages into the two profile rails 53. The rotor 54 can be displaced on the profile rails 53 along the lifting axis 26. An electric motor 55 and a spindle 56 form the propulsion system 25 for the rotor 54. The spindle 56 is rotatably mounted between the two profile rails 53. The rotor 54 has a thread 57 which engages into the spindle 56. The electric motor 55 turns the spindle 56 about its longitudinal axis; the thread 57 converts the rotational movement into a movement along the lifting axis 26. The lifting mechanism 7 illustrated is an example of a telescopic lifting mechanism. Instead of or in addition to profile rails and the rotor 54, tubes which are inserted one into another can be used in the same way. Another propulsion system 25 is based on a toothed rack and a pinion which is driven by the motor. As an alternative, a hydraulic or pneumatic press can also raise the lifting mechanism 7.

The exemplary lifting mechanism 7 can comprise a manually telescopic platform 58 in addition to the power-driven lifting mechanism 7. The platform 58 can be constructed in a comparatively compact manner. The power-driven section can be brought to a basic height by means of the platform. The platform 58 can be a single- or multi-stage platform. The exemplary platform 58 is based on a rail guide.

An exemplary holder 5 has a trough-like tray 59 with a tensioning strap 60. The handle 17 can be positioned in the tray 59 and can be fixed by the tensioning strap 60 in the tray 59. The housing of the portable power tool 6 can be lashed to the holder 5 by a second tensioning strap 61. The holder 5 can preferably be displaced perpendicularly to the lifting axis 26. The holder 5 can be displaceable, for example, on a dovetail guide 62. The user can position the working axis 19 vertically with respect to the wheel axis 29. The holder 5 can comprise an angular setting which permits precise alignment of the working axis 19 parallel to the lifting axis 26. The angular setting comprises, for example, a joint and an adjustment screw.

The lifting mechanism 7 is preferably equipped with a sensor 63 for determining the contact-pressure force on the ceiling 3. For example, the holder 5 is supported in the vertical direction 27 on a spring 64. The contact-pressure force compresses the spring 64. A displacement sensor 65, for example a sliding potentiometer, determines the displacement distance by which the spring 64 is compressed. With the spring constant being known, the sensor 63 determines the contact-pressure force. Other sensors for determining the contact-pressure force can be based on piezoelectric effects, strain gages, etc. Other refinements determine the contact-pressure force indirectly. For example, the sensor 63 comprises evaluation of the power consumption, for example the current consumption, of the propulsion system 25. A correlation of the power consumption and a measure of the contact-pressure force are stored in a table in the sensor. The initial contact pressure of the tool 12 against the ceiling 3 is detected by the sensor 63 as a jump in the contact-pressure force. The sensor 63 indicates to the control station 23 in a control signal that the tool 12 is bearing against the ceiling 3. The control station 23 can correspondingly stop manual control of the lifting mechanism 7 and switch to the working mode. In a preferred variant, a desired value for the contact-pressure force is stored in the control station 23. The desired value can be input or selected by the user beforehand. The desired value is dependent on the tool 12, for example a diameter of the drill. The propulsion system 25 is corrected to a constant contact-pressure force. The sensor 63 can, as part of a protective circuit 66, provide a measurement value for the contact-pressure force. The protective circuit 66 stops the lifting mechanism 7 being raised if the measurement value exceeds a threshold value.

In one refinement, the tool guide 1 can suspend the dynamic balancing when the tool 12 touches the ceiling 3. With the contact point against the ceiling 3, the tool guide 1 can stand statically. The tool guide 1 can switch to a stop mode S5 in which the wheels 28 are locked by a brake 67 (FIG. 9). The balancing and the associated slight oscillating movement stop.

The tool guide 1 has a (contact) sensor 68 which detects contact with the ceiling 3. Typically, the tool 12, consumable material or the portable power tool 6 touches the ceiling 3. The holder 5 touches the ceiling 3 indirectly. The contact sensor 68 outputs a (contact) signal to the controller 10, which contact signal contains coded information as to whether the tool 12 is in contact with the ceiling 3. The contact sensor 68 can evaluate, for example, the contact-pressure force of the lifting mechanism 7 or a measure for the contact-pressure force. The contact sensor 68 indicates contact if the contact-pressure force exceeds a threshold value or a rate of change in the contact-pressure force exceeds a threshold value. The threshold value is preferably dimensioned in such a way that the associated contact-pressure force is sufficient to hold the tool guide 1 in a static stable standing position via the two wheels 28 and the contact point on the ceiling 3. The contact sensor 68 can be realized, for example, by the sensor 63 or an analogous sensor 63.

When the contact signal is applied, the controller 10 preferably suspends balancing of the chassis 9. The controller 10 can delay the suspension until the contact signal is applied for a minimum duration. When the contact signal is applied, the steering system 21 checks whether the lifting mechanism 7 is vertically aligned. If the steering system 21 detects a deviation from the vertical alignment, the control station 23 lowers the lifting mechanism 7 in response thereto. The lowering can take place by a predetermined stroke, for example 1 cm. As an alternative, the stroke can be determined on the basis of the deviation from the vertical alignment and/or the height of the lifting mechanism 7. For example, the stroke is proportional to the product of the deviation in an angular dimension and the current height of the lifting mechanism 7. The tool 12 becomes detached from the ceiling 3. As a result, the contact sensor 68 no longer indicates contact with the ceiling 3. The controller 10 immediately reactivates the balancing by means of the steering system 21. The steering system 21 aligns the lifting mechanism 7 perpendicularly. The controller 10 can repeat the method described in the paragraph iteratively until the lifting mechanism 7 is aligned perpendicularly. The controller 10 subsequently raises the lifting mechanism 7 at least preferably until a contact signal is applied. The tool guide 1 is then vertically aligned.

The chassis 9 preferably has a brake 67. The brake 67 is preferably activated as soon as the tool guide 1 is vertically aligned and the contact signal is applied. The brake 67 is a parking brake which permanently locks the wheels 28 of the chassis 9. The brake 67 is realized, for example, as an motor brake. The brake 67 generates an electromagnetic force which opposes a movement of the wheels 28. The brake 67 can be passive. The electric motors 30 can generate an electric current in the stator 33 in accordance with the principle of a generator if the rotor 31 of said electric motors is rotated. Examples of the electric motors 30 with the principle of a generator are direct-current motors, universal motors, etc. The current which is generated by a generator is short-circuited by the brake 67 via a load resistor. The reactive magnetic field opposes the rotation movement of the rotor 31. As an alternative, a rotation speed sensor or movement sensor can detect a movement. The steering system 21 ascertains a corresponding control signal in order to steer the propulsion system 25 counter to the movement. The brake 67 can also be realized by a mechanical brake in the chassis 9, for example a disk brake or drum brake. The mechanical brake 67 can assist the motor brake.

The tool guide 1 has one or more batteries 34, 69. The batteries 69 supply the steering system 21, the control station 23, the electric motors 30 of the drive 22, the electric motor 55 of the propulsion system and, possibly, the portable power tool 6 with power. The batteries 69 can comprise a stationary battery 34 and one or more removable batteries 69. The stationary battery 34 is preferably integrated in the chassis 9. The tool guide 1 has corresponding electromechanical interfaces for the removable batteries 69. The interfaces correspond, for example, to the interfaces of portable power tools 6. The user can replace discharged batteries 69 with charged batteries 69 and charge the discharged batteries 69 in a separate charging station. The power consumption of the portable power tool 6 is typically significantly above 200 Watts. A correspondingly large capacitance has to be provided by the batteries. The stationary battery 34 is electrically connected to the other batteries 69. A charging regulator 70 charges the stationary battery 34 with the other batteries 69. The charging regulator 70 preferably keeps a charging state of the stationary battery 34 above an emergency value. The user can remove the other batteries 69 without risk. The stationary battery 34 has a sufficient state of charge on account of the emergency value in order to balance the chassis 9 for at least 10 minutes, preferably at least half an hour.

The tool guide 1 enters an (emergency) mode S9 if the state of charge of the batteries 34, 69 drops below the emergency value. The emergency mode ensures a secure standing position of the tool guide 1. The chassis 9 and the steering system 21 are supplied with power. The user can move the tool guide 1 to a charging station or to another desired location. Other consumers are preferably deactivated; in particular the lifting mechanism 7 and the portable power tool 6 are deactivated. For example, the control station 23 can be blocked to inputting by the user. The user can no longer raise the control station 23. The portable power tool 6 can be isolated from the batteries by means of a switch. The lifting mechanism 7 can be automatically retracted to the lowest height in the emergency mode. In the emergency mode, the tool guide 1 can indicate the emergency mode optically or acoustically.

1. A self-aligning tool guide, comprising:
a holder for fixing a portable power tool,
a lifting mechanism on which the holder is mounted, and wherein the lifting mechanism has a propulsion system for raising the holder parallel to a lifting axis;
a self-balancing chassis which has two wheels on a wheel axis, a drive which is coupled to the two wheels, and a steering system,
a center of gravity sensor for detecting a lateral deflection of a center of gravity (G) of the lifting mechanism in relation to the wheel, axis,
wherein the steering system is designed to actuate the drive to output a torque which counteracts the lateral deflection,
an inclination sensor for detecting an inclination of the lifting mechanism in relation to the force of gravity in a frontal plane which is parallel to the wheel axis and parallel to the lifting axis,
a pivot joint by which the lifting mechanism is mounted on the self-balancing chassis, wherein a pivot axis of the pivot joint is inclined in relation to the frontal plane or is perpendicular to the frontal plane,
a pivot drive which is coupled to the pivot joint for adjusting an inclination of the lifting axis in relation to the wheel axis in the frontal plane, and
an inclination controller which is designed to actuate the pivot drive such that the inclination is minimized.

2. The tool guide as claimed in claim 1, comprising a belt drive and/or a linkage by which the pivot drive is coupled to the chassis or to the lifting mechanism for transmitting a torque.

3. The tool guide as claimed in claim 1, having precisely two wheels.

4. The tool guide as claimed in claim 1, wherein the lifting mechanism can be pivoted about the wheel axis.

5. The tool guide as claimed in claim 1, wherein the steering system has a stationary mode in which the steering system is designed to balance the center of gravity (G) by means of the drive.

6. The tool guide as claimed in claim 5, wherein the steering system is designed to vertically align the lifting axis by the drive.

7. The tool guide as claimed in claim 1, wherein the lifting mechanism is rigidly coupled to a stator of the drive.

8. The tool guide as claimed in claim 1, wherein the holder is designed to arrange a working axis of the portable power tool, which is fixed in the holder, perpendicularly to the wheel axis.

9. The tool guide as claimed in claim 8, wherein the holder can be displaced transversely to the lifting axis.

10. The tool guide as claimed in claim 1, wherein the lifting mechanism is limited to a single-axis, translatory movement along the lifting axis.

11. A control method for a tool guide as claimed in claim 1, comprising
detecting a lateral deflection of the center of gravity of the lifting mechanism in relation to the wheel axis of the tool guide,
actuating the drive such that the drive outputs a torque which counteracts the deflection.

12. The tool guide as claimed in claim 3, wherein the lifting mechanism can be pivoted about the wheel axis.

13. The tool guide as claimed in claim 2, wherein the steering system has a stationary mode (S2) in which the steering system is designed to balance the center of gravity (g) by the drive.

14. The tool guide as claimed in claim 3, wherein the steering system has a stationary mode (S2) in which the steering system is designed to balance the center of gravity (G) by the drive.

15. The tool guide as claimed in claim 4, wherein the steering system has a stationary mode (S2) in which the steering system is designed to balance the center of gravity (G) by the drive.

16. The tool guide as claimed in claim 2, wherein the lifting mechanism is rigidly coupled to a stator of the drive.

17. The tool guide as claimed in claim 3, wherein the lifting mechanism is rigidly coupled to a stator of the drive.

18. The tool guide as claimed in claim 4, wherein the lifting mechanism is rigidly coupled to a stator of the drive.

19. The tool guide as claimed in claim 5, wherein the lifting mechanism is rigidly coupled to a stator of the drive.

20. The tool guide as claimed in claim 6, wherein the lifting mechanism is rigidly coupled to a stator of the drive.
